(19) United States
(12) Patent Application Publication
(10) Pub. No.: US 2003/0205094 A1
(43) Pub. Date: Nov. 6, 2003

(54) Automated airside volume measurement method

(76) Inventor: Brandon Thomas Plum, San Diego, CA (US)

Correspondence Address: Mr. Brandon T. Plum, 14978 SATANAS STREET, San Diego, CA, 92129, US

(21) Appl. No.: 10/138,822

(22) Filed: May 6, 2002

(51) Int. Cl. G01F 1/00

(52) U.S. Cl. 73/861

(57) ABSTRACT

This invention is the automatic data collection of the airside velocity measurement and the sensor location measurement as recorded during the airside volume measurement or air balance process. The data is automatically output to a computing or data-logging device for immediate or later analysis, eliminating the human error associated with measurement and data recording.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to the field of endeavor of Heating, Ventilating, and Air Conditioning (HVAC). In particular, this invention pertains to the process of measurement of the airflow in HVAC ductwork and the process of measurement of the velocity profile in HVAC ductwork. The process of airflow measurement in HVAC ductwork has been

documented in the following references:

ASHRAE. 1988. Process for Measurement, Testing, Adjusting and Balancing of Building Heating, Ventilation, Air-conditioning and Refrigeration Systems. Standard 111-1988. American Society of Heating, Refrigerating, and Air-Conditioning Engineers, Inc., Atlanta, Ga.

AABC. 2002. National Standards for Total System Balance, 6th ed. Associated Air Balance Council, Washington, D.C.

The process of airside measurement in HVAC ductwork includes measurement of airflow velocities at measured and systematically selected locations within the air duct to be measured. Measurements are taken at predetermined locations in a grid pattern at a single traverse plane in the air duct. Given the airflow velocity at these pre-selected points within the air duct, the overall airflow is later calculated.

The common source for error in this process is the difficulty in precisely locating the velocity sensor within the air duct, while simultaneously determining the velocity measured, and correctly recording these measurement combinations for later analysis.

This invention automates these measurements and the data logging process, thus reducing the element of human error and increasing the overall accuracy/precision of the measurement process.

### BRIEF SUMMARY OF THE INVENTION

My invention is to automate the HVAC airside volume measurement process. The measurement is automated by simultaneously measuring the precise location and the airside velocity. The velocity measurement can be made using any accepted mechanical (i.e. pitot tube) or electronic (i.e. lost heat transducer) measuring device. The location measurement can be made by a mechanical, optical, or magnetic device, connected to the velocity measurement probe. These two values are output to a computing device capable of storing the data table. By automating the data gathering process, the accuracy and/or precision of the overall measurement is greatly improved. The technician will input the size of the duct into the computing device. The device will output the specific locations of the probe insertions. The technician will insert the probe into the duct. The probe will simultaneously output the precise location of the probe within the duct and the velocity at that point. The computing device will output the final airside volume measurement.

### BRIEF DESCRIPTION OF THE SEVERAL VIEWS OF THE DRAWING

Not Applicable

### DETAILED DESCRIPTION OF THE INVENTION

The invention is the process of collecting a set of discrete data points, automatically recording these discrete data points, and using the discrete data points to calculate the airside volume of an HVAC duct or develop a velocity profile of the airflow with an HVAC duct.

The velocity sensor is inserted into the HVAC air duct. As the sensor is inserted, the position of the sensor within the duct and the velocity at this point are automatically output to a computing or data collecting device.

The actual measurement of the airflow velocity may be determined using a pitot tube (with electronic output capability) or using a thermal dispersion sensor (with electronic output capability).

The actual measurement of the sensor position within the air duct may be determined using a mechanical, magnetic, or optical device calibrated to the shaft of the air velocity sensor, and temporarily fixed to the side of the air duct at the point of insertion.

The improvement of the airside balance process is that the measurements are automated. The technician is not required to make the air velocity measurement, simultaneously note the location of the sensor within the duct, and manually record these data points for later calculation. These measurements are recorded automatically for later computations.

The full development of this invention is a computing device that would fully automate and assist the technician in precisely determining the airside volume. The technician would enter the dimensions of the specific duct to be measured. The computing device would illustrate the required insertion points for the specific duct dimensions. The technician would drill insertion hole as illustrated and begin inserting the velocity sensor in each traverse location, in order, as specified by the computing device. As the velocity sensor is inserted and moved across the full traverse of the air duct, the computing device would record the velocity/location data points. After the technician is finished with all of the required sensor traverses, the computing device outputs the total airside volume or outputs a three-dimension graphical representation of the velocity profile.

The airside volume can be computed using any of the industry standard accepted methods (i.e. Equal Area, or Log-Tchebycheff).

The airside volume measurement is important (and required) for balance and certification of the HVAC airside system.

The velocity profile can be very useful for mitigating problems in the airside system (i.e. poor fan performance, high static pressure loss, air noise within the HVAC duct, etc.).

1. What I claim as my invention is the mechanical measurement of the air velocity sensor position with the duct during the airside volume measurement process.

2. What I claim as my invention is the optical measurement of the air velocity sensor position with the duct during the airside volume measurement process.

3. What I claim as my invention is the magnetic measurement of the air velocity sensor position with the duct during the airside volume measurement process.

4. What I claim as my invention is the automatic measurement of the air velocity sensor position with the duct during the airside volume measurement process.

5. What I claim as my invention is the automatic output of the air velocity measurement and sensor position measurement within the air duct as a discrete data point to a computing device.

6. What I claim as my invention is the automatic output of the air velocity measurement and sensor position measurement within the air duct as a discrete data point to a data-logging device.

7. What I claim as my invention is the calculation of the total duct airflow using the automatic collection of the air velocity measurement and sensor position measurement data.

8. What I claim as my invention is the development of a velocity profile of the airflow within the air duct using the automatic collection of the air velocity measurement and sensor position measurement data.
